(19) United States
(12) Patent Application Publication
(10) Pub. No.: US 2024/0015199 A1
(43) Pub. Date: Jan. 11, 2024

(54) Method and Apparatus for Delivering Musical, Theatrical, and Film Performance over Unreliable Channels

(71) Applicant: Eswar Priyadarshan, Los Alto, CA (US)

(72) Inventor: Eswar Priyadarshan, Los Alto, CA (US)

(21) Appl. No.: 18/220,518

(22) Filed: Jul. 11, 2023

Related U.S. Application Data
(60) Provisional application No. 63/368,117, filed on Jul. 11, 2022.

(51) Int. Cl. H04L 65/75; H04L 65/756; H04L 69/04

(52) U.S. Cl. CPC H04L 65/762; H04L 65/756; H04L 69/04

(57) ABSTRACT

A streaming service server provides stream content subject to a variety of different compression rates which preferentially maintain high audio quality with increasing video degradation as bandwidth decreases, recognizing different perceptive quality dependencies for video versus music.

### CROSS REFERENCE TO RELATED APPLICATION

This application claims the benefit of U.S. provisional application 63/368,117 filed Jul. 11, 2022 and hereby incorporated by reference.

### STATEMENT REGARDING FEDERALLY SPONSORED RESEARCH OR DEVELOPMENT

—

### BACKGROUND OF THE INVENTION

The present invention relates generally to a method and apparatus for streaming musical and other similar performance content particularly to users having unreliable wireless connections.

Live streaming, where a musical performance is delivered in real-time or near real-time (for example from an archive) over the Internet to a geographically dispersed audience, provides great promise in allowing artists to connect with and cultivate fans in situations where attending a live performance is not practical. In a live streaming event, a performance may be captured using digital audio and video equipment and broadcast over the Internet using a standard such as HTTP live streaming (HLS) receivable by a wide variety of web browsers, media players, and mobile devices. HLS and similar standards provide the ability to send data at different bit rates according to the bandwidth of the receiving device, for example, providing higher bandwidths to high-speed wire or fiber connections and lower bandwidths to mobile devices operating through cellular telephone connections or weak Wi-Fi connections.

In this latter case, the signal can be substantially compressed or limited, significantly affecting the user's experience. Such bandwidth limitations are normally associated with mobile devices without wire connections; however, such devices are increasingly preferred for streaming, substantially affecting the user experience of a substantial percentage of music fans.

The problems of low bandwidth associated with wireless connections are anticipated to be remedied somewhat with new 5G communication protocols; however, such protocols are not currently widely available nor are likely to be available to a wide range of individuals in the near future.

### SUMMARY OF THE INVENTION

The present inventor has recognized that a user's perception of streaming quality of a musical performance is disproportionately affected by the audio quality as compared to the video quality. That is, with high audio quality, the video quality of the streaming performance may be substantially reduced with limited or no effect on enjoyment.

The present invention accordingly provides a compression protocol offering different encoded bit rates for audio and video that provide successively greater compression of the video signal when the user's bandwidth is limited in favor of retaining the highest quality (least compression) of the audio channel. This is of particular importance because the video bandwidth is often many times that required by the audio bandwidth for the same degree of compression, and so the necessary degree of compression for the wireless channel can be achieved primarily with video compression or reduction. The invention can work within the existing HLS standard thus eliminating the need to modify a large installed base of media players on consumer devices.

These particular objects and advantages may apply to only some embodiments falling within the claims and thus do not define the scope of the invention.

### BRIEF DESCRIPTION OF THE DRAWINGS

FIG. 1 is a simplified block diagram of a streaming system suitable for use with the present invention providing a ladder of different stream qualities;

FIG. 2 is a block diagram of adaptive bit rate streaming used in the present invention using a ladder table for identifying stream files;

FIG. 3 is a simplified example of a ladder table per the present invention; and

FIG. 4 is a flowchart of a program executed by the streaming system.

### DETAILED DESCRIPTION OF THE PREFERRED EMBODIMENT

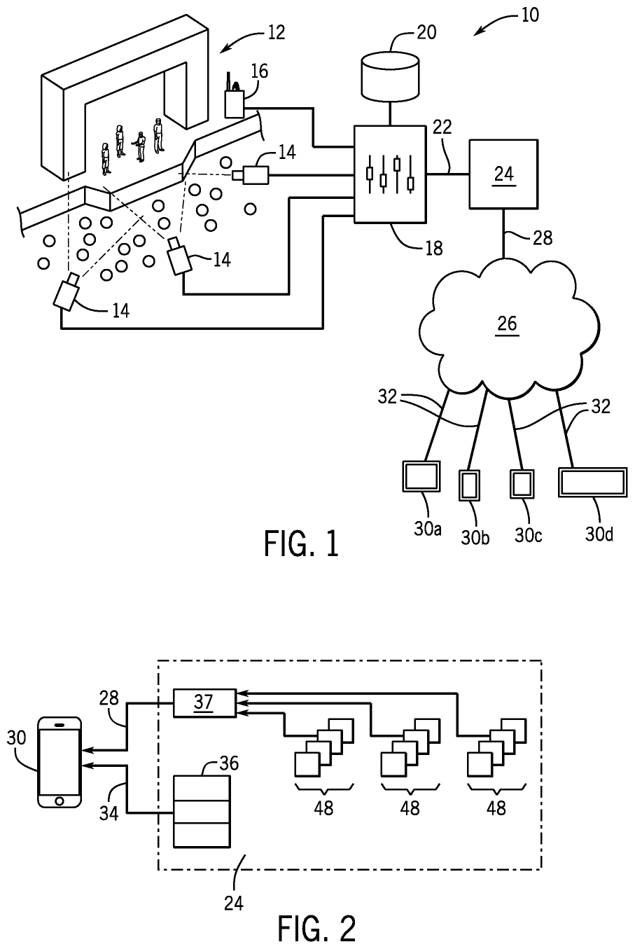

Referring now to FIG. 1, a streaming system 10 according to the present invention may provide for live streaming of an event 12, for example, captured with multiple cameras 14 and audio devices 16 (here represented as wireless microphones and the like). Each of these cameras 14 and audio devices 16 may provide data streams to a mixer device 18 which may select among the cameras 14 and audio devices 16, control their levels, and splice in prerecorded material 20 as desired. The result is a combined audio video stream 22 which may be provided to a stream server 24, for example, Open Broadcasts Software (OBS) or the like. This combined audio video stream 22 may have a predetermined audio bandwidth that is fixed and communicated to devices receiving the stream.

The stream server 24 may provide an encoded stream 28 of the video and audio data via the Internet 26 to a variety of end-user devices 30a-30d representing, for example, cell phones, tablets, home theater systems, and desktop personal computers. Each of the devices 30 may have different capabilities in terms of processing power and display resolution, for example, providing screen sizes that vary between 1920×1080 pixels for high definition video display and 426×240 pixels for a small cell phone. Likewise, each of the devices 30 may be associated with a different wireless or wired channels 32, limiting the bandwidth receivable from the Internet 26 (for example, ranging from a cable or optical fiber connection, through Wi-Fi) driven by the communication protocols, various signal strengths, and possibly intermittent connections.

In one embodiment, the encoded stream 28 may adopt a standard such as HTTP Live Streaming (HLS), a standard developed by Apple, Inc., or MPEG-DASH, a separate standard, that allows adaptive bit rate streaming that can accommodate both different devices 30 and different channels 32. Referring to FIG. 2, in adaptive bit rate streaming, the device 30 receives the encoded stream 28 and measures internal run-time statistics with respect to buffer under runs and the like indicating how fast streaming data is arriving at the device 30 relative to the playing of the media on the device 30. The device 30 may then provide a bit rate request 34 to the stream server 24 reflecting both the capabilities of the device 30 (processor speed and display size) and its recent history with respect to receiving the encoded stream 28. The rate request 34 is received by a manifest or ladder table 36 providing a set of predetermined options for the bit rates of the transmission to the device 30. Based on the rate request 34, the stream server 24 will select a different “rung” of the ladder table 36 to control the streaming protocol.

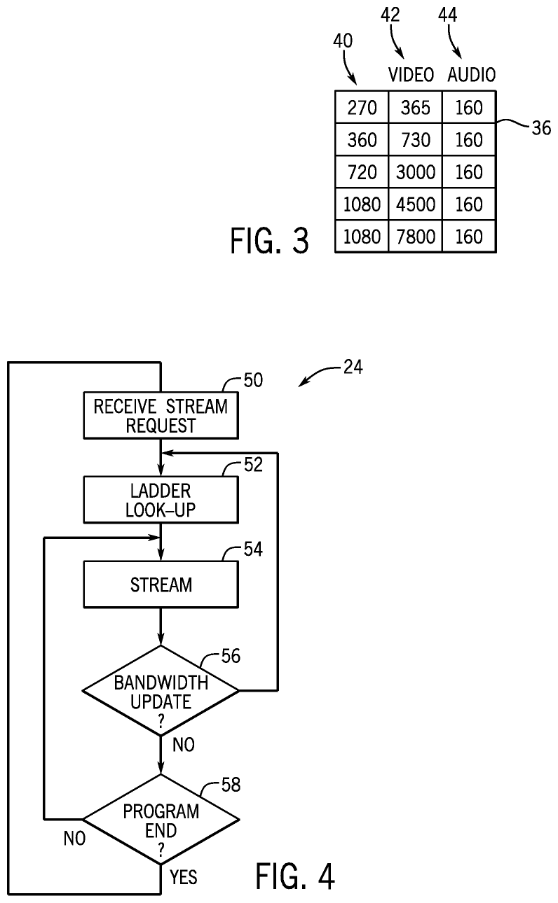

Referring also to FIG. 3, the ladder table 36 will have a set of logical rows representing different bit rate transmissions of the live stream, for example, in this case indexed by a first column 40 being a representation of the display size of the device 30. Note that a given display size may have multiple row entries associated with different bit rates. Each of the rows associated with a video bit rate 42 primarily reflect the demands of different display sizes but also indicate different forms of compression or protocol and an audio bit rate 44 that will normally be set to lower rates for those rows associated with lower overall bit rates (for example, to be sent to a cell phone with a slow Internet connection through cellular towers) and to higher rates for devices having higher-quality hardware and improved or high-speed Internet connections. The ladder table 36 may be generated by the stream server 24 which serves to demultiplex (demux) the live stream into different bit rates for audio and video while maintaining synchronization between audio and video for each combination. Generally, the ladder, as depicted, indicates indices that link to particular stream files 48 or compressor settings for a high bit rate stream file.

In the ladder table 36, bit rates may vary, for example, between 365 kb per second to 7800 kb per second for high definition displays over good Internet connections. Audio bit rates may vary between 32-60 kb per second, for example, for basic stereo using the AAC codec. In part because the rungs of the ladder table 10 are to be designated by device display capabilities, cell phones having lesser display sizes will tend to have higher audio and video compression. The present invention, however, loads the ladder table 36 with a high audio bit rate for all rungs of the ladder despite the fact that this high rate takes a substantial portion of the bit rate for low rungs. Generally, this high bit rate may be above the minimum bit rate for the codec and above 100 kb per second.

Referring again to FIG. 2, the ladder table 36 may then direct the device 30 to one of a set of different stream files 48 (provided by a fileserver 37 with different URLs) associated with different rungs or rows of the ladder table 36. In each of these different stream files 48, the video stream 22 (shown in FIG. 1) will have been subject to a different compression according to the desired characteristics of the row expressed as a video bit rate 42 and audio bit rate 44. Generally, the video portion of the stream will be subject to different compression rates that coordinate with the audio portion of the stream to maintain audio and video synchrony. The device 30, for example, may select among the streams by moving to a relative or absolute URL associated with the server 24 and tied to a particular stream file 48.

As the experience of the playing device 30 changes, for example, in a car moving in and out of cell phone tower range, the device 30 may switch between the stream files 48. In the present invention, as the bandwidth of the channel 32 degrades, however, audio bandwidth is preserved over video bandwidth.

The invention contemplates that the stream server 24 may also archive the resulting stream by either archiving the entire ladder or a high bit rate ladder rung which can be later demultiplex into the ladder.

Referring now to FIG. 4, the stream server 24 may provide a processor and electronic memory holding a stored program and the necessary stream files 48 and execute a program thread to receive requests for streamed data as indicated by process block 50, each request including a program identifier and a bandwidth specifier that can be used to index the ladder table 36 per process block 52. In its simplest form, the bandwidth specifier is a device display size (or requested display size) however the invention also contemplates that a specific bandwidth can be requested or bandwidth may be specified relative to a previous request to increase or decrease bandwidth by one increment on the ladder table 36.

At process block 54 the stream server 20 then begins streaming the data to the given mobile or remote device, waiting for possible bandwidth updates from that device per process block 56. Upon such an update request, the program returns to process block 52 again to consult the ladder table 36. Otherwise, streaming continues with a monitoring of whether the program has ended per process block 58, after which the program thread may again review requests for streams

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A live streaming server system comprising:
an electronic server computer executing a program in stored media to:
(a) receive a first request for streamed video and audio from a given remote device indicating a first desired streaming bandwidth;
(b) serve the streamed video and audio to the given remote device with a first video compression based on the desired streaming bandwidth and second audio compression;
(c) receive a second request for the streamed video and audio from the given remote device indicating a second desired streaming bandwidth lower than the first desired streaming bandwidth for the streamed video and audio; and
(d) serve the streamed audio and video to the given remote device with a second video based on the desired streaming bandwidth compression and second audio compression wherein the second video compression is disproportionately greater than the first video compression than the second audio compression is greater than the first audio compression.

2. The life streaming server system of claim 1 wherein the first and second audio compressions are the same.

3. The life streaming server system of claim 1 wherein the streamed audio is music.

4. The life streaming server system of claim 1 wherein the desired streaming bandwidth is designated by a display size.

5. The life streaming server system of claim 1 wherein the desired streaming bandwidth is designated by a value based on buffer underruns.

6. The live streaming server system of claim 1 wherein the bit rate for the audio portion is predetermined at the live streaming server and communicated to the given remote device.

7. The live streaming server system of claim 1 wherein the program further executes to archive the stream for later viewing with the high bit rate for audio portions of the stream.

8. The live streaming server of claim 1 wherein the program further executes to multiplex a source stream to produce the different versions of the live stream that maintain audio and video synchrony.
